(19) United States
(12) Patent Application Publication
(10) Pub. No.: US 2022/0215405 A1
(43) Pub. Date: Jul. 7, 2022

(54) SYSTEMS AND METHODS FOR A USER DIGITAL PASSPORT

(71) Applicant: FMR LLC, Boston, MA (US)

(72) Inventors: Byung Chun, Boston, MA (US); Lincoln Roach, Boston, MA (US); Christopher Yu, Boston, MA (US); Divya Mahajan, Boston, MA (US); Benjamin Dixon, Boston, MA (US)

(21) Appl. No.: 17/143,505

(22) Filed: Jan. 7, 2021

(51) Int. Cl. G06Q 30/02; G06F 16/901; G06F 16/21

(52) U.S. Cl. CPC G06Q 30/0201; G06N 20/00; G06F 16/211; G06F 16/9024

(57) ABSTRACT

Systems and methods for synchronizing user activity across digital channels. The method includes receiving a first request corresponding to a first user activity on a first digital channel via a user device. The method also includes storing a first real-time activity record corresponding to the first request in a database. The method further includes updating a user profile based on the first real-time activity record. The method also includes receiving a second request corresponding to a second user activity on a second digital channel via the user device. The method further includes determining an intended transaction corresponding to the second request using a semantic knowledge graph. The method also includes generating a customized digital activity based on the user profile and determined intended transaction. The method further includes generating for display the customized digital activity on the user device.

### FIELD OF THE INVENTION

The present invention relates generally to systems and methods for generating a user digital passport, including systems and methods for synchronizing user activity across digital channels.

### BACKGROUND OF THE INVENTION

Customer experiences are often developed by many teams throughout large organizations. These teams or experience owners attempt to coordinate consistent experiences for their customers but have historically treated each customer as an almost exclusive customer of their product. Consistency of experience is often delegated to the data layer of an application and very little consideration is given to experience level consistency as each experience owner strives to innovate, improve, and evolve on the user interface. These experience owners control the implementation of their own User Interface and Application layers, and select from a set of data sources and APIs to populate their experiences.

Currently, it is left to the customer to sift through the viewpoints of each of the experiences that they frequent to make the right decision on how to best achieve the task they desire. Despite the best efforts of experience owners to keep in synch, there is no experience level check for consistency that ensures that a call to action from one experience will not conflict with another experience. Similarly, these experiences or applications do not have knowledge of concurrent sessions across devices (or even in the same browser) so the same user may be prompted for the same things or conflicting things as the data layers struggle to keep up with simultaneous updating across multiple data centers. Therefore, there is a need for systems and methods that can synchronize user experiences across experiences or applications in real-time.

### SUMMARY OF THE INVENTION

Accordingly, an object of the invention is to provide systems and methods for synchronizing user activity across digital channels. For example, it is an object of the invention to provide systems and methods for updating a user profile based on a real-time activity record. It is an object of the invention to provide systems and methods for determining an intended transaction corresponding to a user request using a semantic knowledge graph. It is an object of the invention to provide systems and methods for generating a customized digital activity based on a user profile and intended transaction.

In some aspects, a computerized method for synchronizing user activity across digital channels includes receiving, by a server computing device, a first request corresponding to a first user activity on a first digital channel via a user device. The method further includes storing, by the server computing device, a first real-time activity record corresponding to the first request in a database. The method also includes updating, by the server computing device, a user profile based on the first real-time activity record.

Further, the method includes receiving, by the server computing device, a second request corresponding to a second user activity on a second digital channel via the user device. The method also includes determining, by the server computing device, an intended transaction corresponding to the second request using a semantic knowledge graph. Further, the method includes generating, by the server computing device, a customized digital activity based on the user profile and determined intended transaction. The method also includes generating, by the server computing device, for display the customized digital activity on the user device.

In some embodiments, the server computing device is further configured to store a second real-time activity record corresponding to the second request in the database. For example, in some embodiments, the server computing device is further configured to update the user profile based on the second real-time activity record.

In some embodiments, the semantic knowledge graph includes entity capability models. In other embodiments, the first real-time activity record includes a time stamp corresponding to the first request. In some embodiments, the server computing device is further configured to determine the intended transaction based on the first request and the second request.

In other embodiments, the server computing device is further configured to generate for display the customized digital activity on the first digital channel via the user device. In some embodiments, the server computing device is further configured to generate for display the customized digital activity on the second digital channel via the user device.

In other embodiments, the server computing device is further configured to generate for display the customized digital activity on a second user device. For example, in some embodiments, the server computing device is further configured to receive the second request corresponding to the second user activity on the second digital channel via a second user device.

In some aspects, a system for synchronizing user activity across digital channels includes a server computing device communicatively coupled to a user device and a database over a network. The server computing device is configured to receive a first request corresponding to a first user activity on a first digital channel via the user device. The server computing device is also configured to store a first real-time activity record corresponding to the first request in the database. Further, the server computing device is configured to update a user profile based on the first real-time activity record.

The server computing device is also configured to receive a second request corresponding to a second user activity on a second digital channel via the user device. The server computing device is further configured to determine an intended transaction corresponding to the second request using a semantic knowledge graph. Further, the server computing device is configured to generate a customized digital activity based on the user profile and determined intended transaction. The server computing device is also configured to generate for display the customized digital activity on the user device.

In some embodiments, the server computing device is further configured to store a second real-time activity record corresponding to the second request in the database. For example, in some embodiments, the server computing device is further configured to update the user profile based on the second real-time activity record.

In some embodiments, the semantic knowledge graph includes entity capability models. In other embodiments, the first real-time activity record includes a time stamp corresponding to the first request. In some embodiments, the server computing device is further configured to determine the intended transaction based on the first request and the second request.

In other embodiments, the server computing device is further configured to generate for display the customized digital activity on the first digital channel via the user device. In some embodiments, the server computing device is further configured to generate for display the customized digital activity on the second digital channel via the user device.

In other embodiments, the server computing device is further configured to generate for display the customized digital activity on a second user device. For example, in some embodiments, the server computing device is further configured to receive the second request corresponding to the second user activity on the second digital channel via a second user device.

Other aspects and advantages of the invention can become apparent from the following drawings and description, all of which illustrate the principles of the invention, by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of an exemplary data communications network, according to embodiments of the technology described herein.

FIG. 2 is a block diagram of an exemplary server computing device and an exemplary user device, according to embodiments of the technology described herein.

FIG. 3 is a diagram showing a visualization of an exemplary application experience ownership architecture, according to embodiments of the technology described herein.

FIG. 4 is a diagram showing a visualization of an exemplary architecture for synchronizing user activity across digital channels, according to embodiments of the technology described herein.

FIG. 5 is a diagram showing a visualization of exemplary intent naming scheme, according to embodiments of the technology described herein.

FIG. 6 is a diagram showing a visualization of an exemplary architecture for synchronizing user activity across digital channels, according to embodiments of the technology described herein.

FIG. 7A is a diagram showing a visualization of exemplary knowledge graph, according to embodiments of the technology described herein.

FIG. 7B is a diagram showing a visualization of exemplary knowledge graph, according to embodiments of the technology described herein.

FIG. 8 is a flow diagram of a computer-implemented method for synchronizing user activity across digital channels using the exemplary architectures of FIG. 4 and FIG. 6, according to embodiments of the technology described herein.

### DETAILED DESCRIPTION OF THE INVENTION

In some aspects, the systems and methods described herein can include one or more mechanisms or methods for synchronizing user activity across digital channels. The system and methods can include mechanisms or methods for updating a user profile based on a real-time activity record. The systems and methods described herein can include mechanisms or methods for determining an intended transaction corresponding to a user request using a semantic knowledge graph. The systems and methods described herein can include mechanisms or methods for generating a customized digital activity based on a user profile and intended transaction.

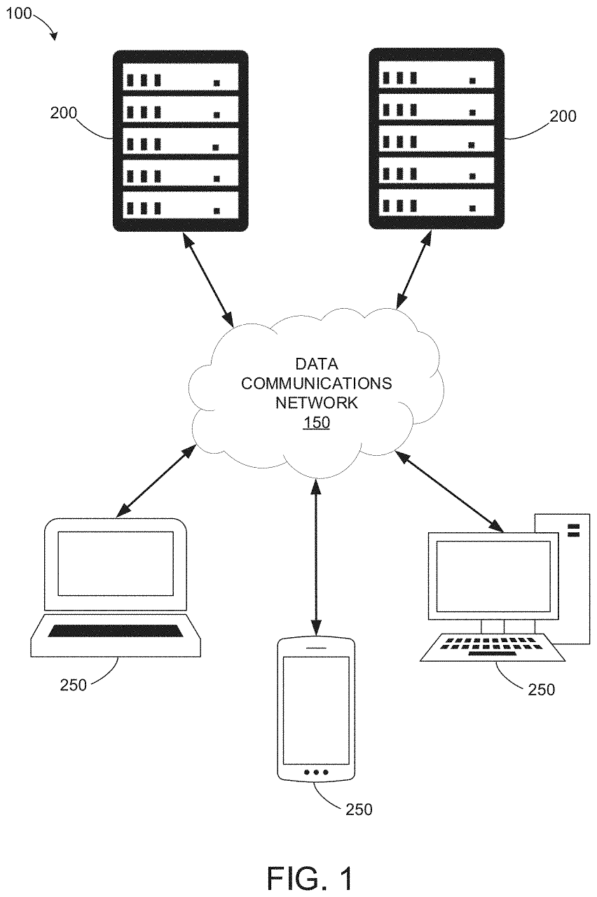

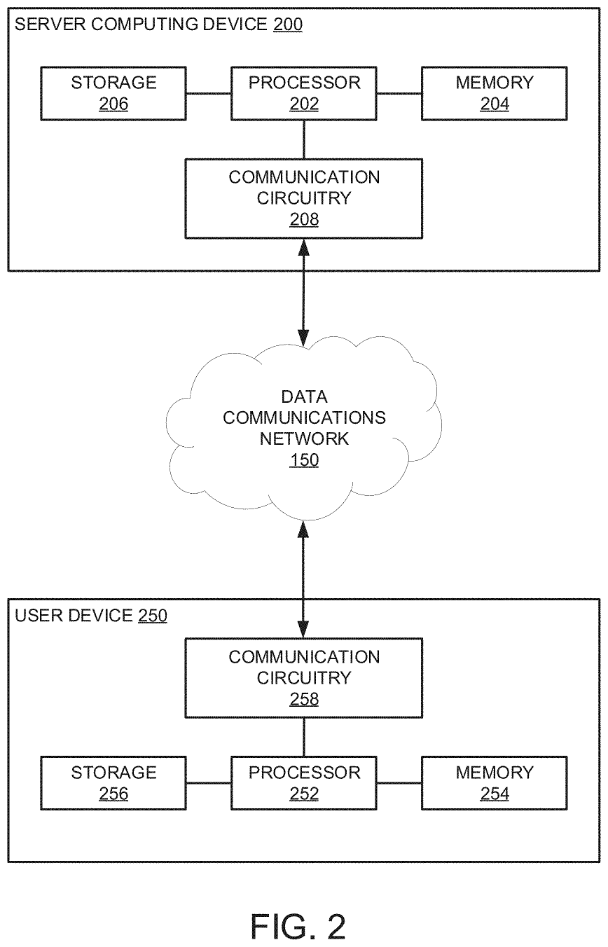

The systems and methods described herein can be implemented using a data communications network, server computing devices, and mobile devices. For example, referring to FIGS. 1 and 2, an exemplary communications system 100 includes data communications network 150, exemplary server computing devices 200, and exemplary user devices 250. In some embodiments, the system 100 includes one or more server computing devices 200 and one or more user devices 250. Each server computing device 200 can include a processor 202, memory 204, storage 206, and communication circuitry 208. Each user device 250 can include a processor 252, memory 254, storage 256, and communication circuitry 258. In some embodiments, communication circuitry 208 of the server computing devices 200 is communicatively coupled to the communication circuitry 258 of the user devices 250 via data communications network 150. Communication circuitry 208 and communication circuitry 258 can use Bluetooth, Wi-Fi, or any comparable data transfer connection. The user devices 250 can include personal workstations, laptops, tablets, mobile devices, or any other comparable device.

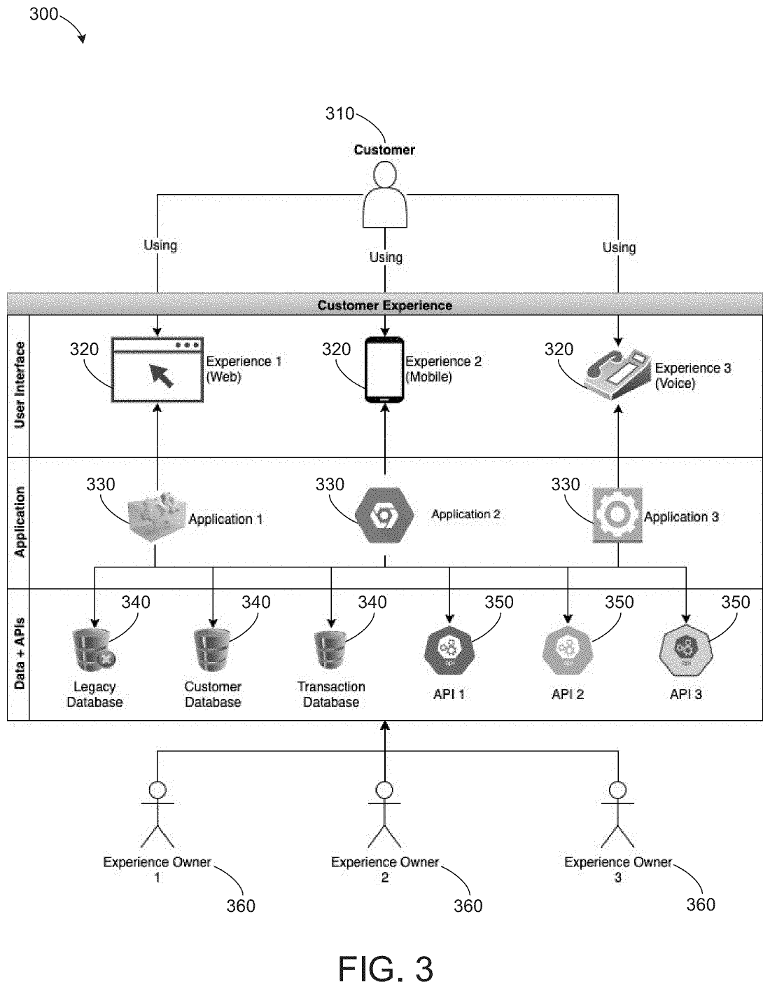

Referring to FIG. 3, an exemplary application experience ownership architecture 300 is illustrated. For every customer or user 310, there are various experiences 320 as users 310 interact with an organization's services. For example, users 310 can interact with experiences 320 via user devices 250. Each experience 320 is achieved through an application 330, relying on information stored on databases 340 and application program interfaces (APIs) 350. Each experience owner or team 360 control the implementation of their own User Interface 320 and Application 330 layers, and select from a set of data sources 340 and APIs 350 to populate their experiences. The systems and methods described herein provide mechanisms or methods for synchronizing user activity across digital channels.

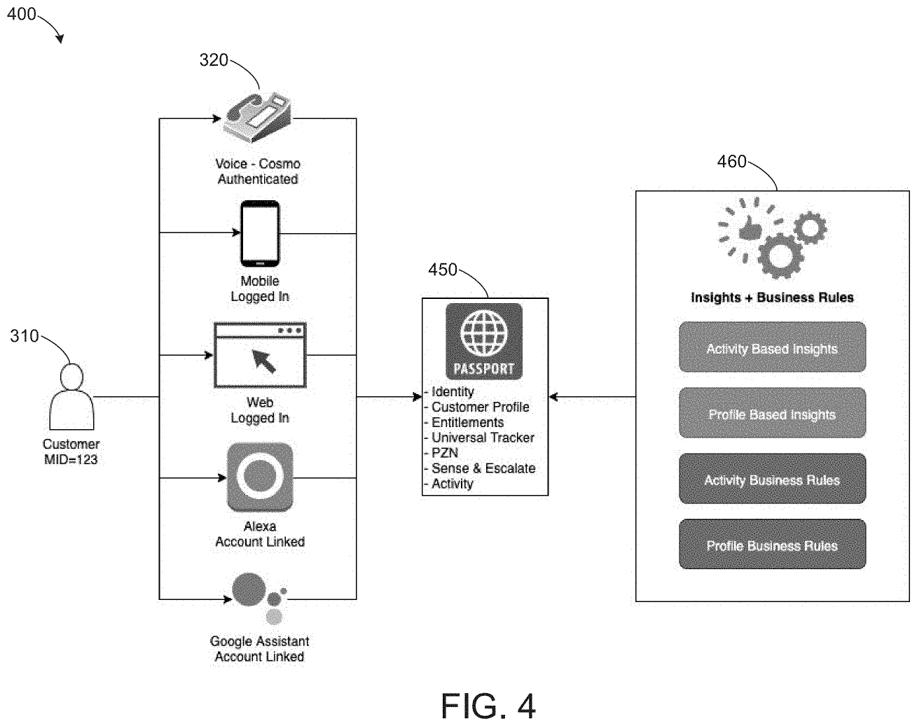

For example, an exemplary architecture 400 for synchronizing user activity across digital channels using communications system 100 is illustrated in FIG. 4. Architecture 400 enables experience owners 360 to define consistent and relevant experiences 320 to users 310 wherever they chose to engage. Architecture 400 includes a digital passport 450 that provides a real-time view of the user 310 for use with business rules and machine learning insights 460 to provide a coordinated and consistent experience for the user 310. In some embodiments, digital passport 450 is designed to provide a view of the customer 310, including insights and business rule execution based on that view, to provide experience consistency much closer to the experience layer so that what is important to the customer 310 (regardless of experience 320) can be brought to the forefront. Digital passport 450 enables efficient, real-time traversal of a structured intent-based taxonomy. This allows for the surfacing of timely, experience-relevant data, automatically removing noise and improving data relevancy across independent products.

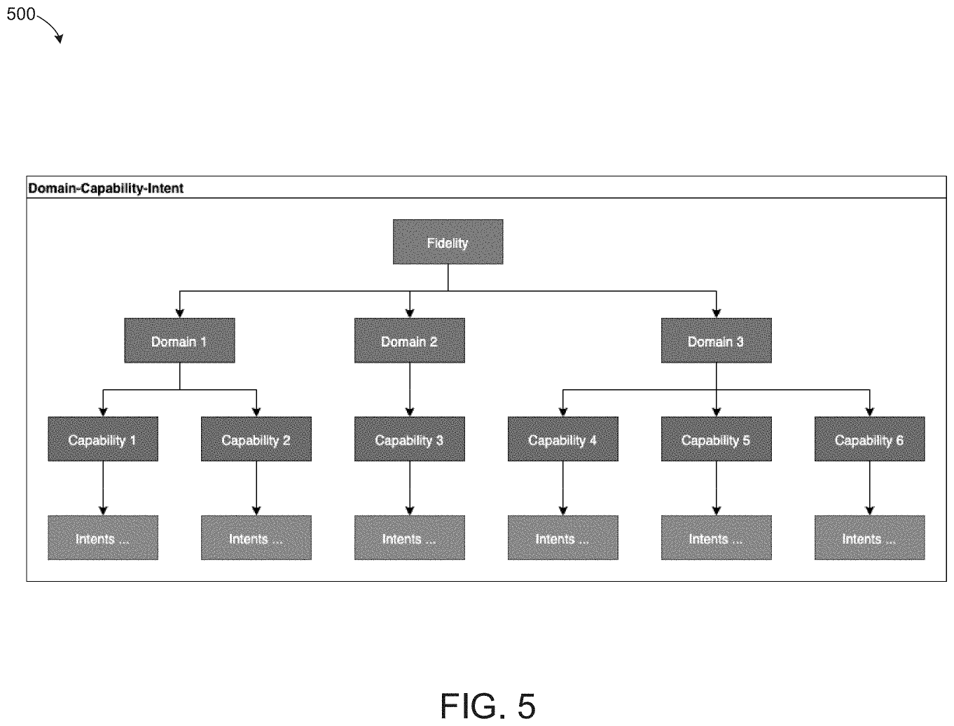

In some embodiments, digital passport 450 can be integrated throughout all experiences 320 such that experience owners 360 can respond to up-to-date information and insights to craft coordinated experiences across channels and experiences 320. Similarly, all experiences 320 can stamp the digital passport 450 with an enterprise accepted customer intent named according to an Intent Naming Scheme. This allows for normalized insights and business rules 460 to be run on the activity from any experience 320. For example, referring to FIG. 5, exemplary intent naming scheme 500 is illustrated.

A normalized hierarchical schema 500 enables creating a semantic knowledge graph and depicting the relationship between business entities thereby empowering understanding users' needs. The relationships in the knowledge graph can also be used by the machine models to suggest other related topics or services pertaining to the users' ask leading to a more enriched experience. The digital passport 450 uses a logical hierarchical domain, business capability, sub capability, intent taxonomy to store data. Domain is the largest entity in an organization. Underneath each domain, there are business capabilities that describe what group of actions can be undertaken for a user. Intents are the most granular entities of the scheme that describe the specific action that the user intended to perform. This format allows for multiple benefits. For example, the digital passport 450 intent taxonomy enables the retrieval of data relevant to a particular experience 320 within a domain. Retrieving only relevant data allows the experience to react faster, more accurately, and more consistently using a more relevant data set with less noise. Because the hierarchy is logical, the data can be stored in any format (for example, time-series) that allows machines to easily scan the data and derive insights. The taxonomy can serve as a hyper-parameter when building machine learning models, or as a direct input to the model improving prediction accuracy.

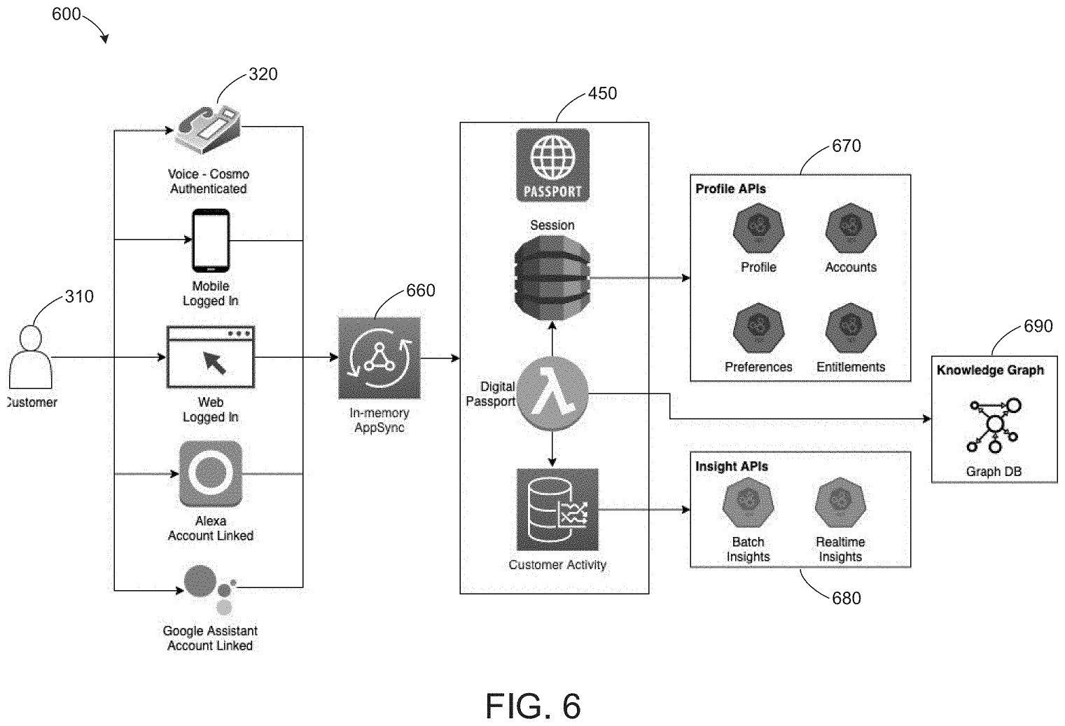

In some embodiments, the implementation of this functionality is able to scale to concurrently support each user 310 across all the channels that are important to them. The solution can synchronize a user's traversal of the knowledge graph in near real-time so that time-sensitive and relevant insights/business rule outcomes can be achieved. In some embodiments, the large-scale capacity and low latency that is required for this functionality can be enabled by 12-factor application design principles and high-level services provided by cloud computing vendors. For example, referring to FIG. 6, an exemplary architecture 600 for synchronizing user activity across digital channels using communications system 100 is illustrated.

Architecture 600 includes a digital passport 450 that provides a real-time view of the user 310 through experiences 320. Architecture 600 includes AppSync 660 which is a cross-channel synchronization tool which ensures the user's digital passport 450 is up to date across all active channels including any changes that they are currently making. Architecture 600 includes scalable compute solutions (ex. AWS Lambda/GCP functions) or automatically scaled application containers to create the digital passport 450 by calling profile APIs 670 and insight APIs 680. In some embodiments, architecture 600 includes scalable caching, or auto-scaled, low-latency storage, to minimize re-requesting the same data across channels and reducing cross channel latency surrounding slow APIs. In some embodiments, architecture 600 includes a user event feed which includes a close to real-time feed of events and transactions that the user 310 is currently executing. The user event feed can be stored in a time series data store to derive insights over a period and is categorized by the specification of the knowledge graph.

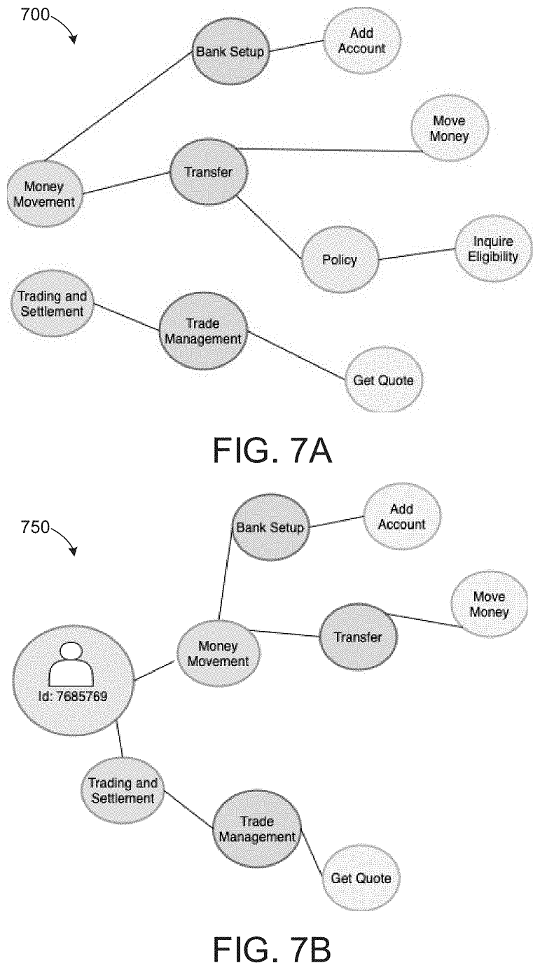

Architecture 600 also includes a traversable knowledge graph 690 which is a knowledge graph adhering to the Intent Naming Scheme 500. Knowledge graph 690 allows for live traversal of nodes within the tree such as a graph database or other in memory representation. For example, exemplary knowledge graphs 700 and 750 are illustrated in FIGS. 7A and 7B, respectively. Knowledge graph 700 is a hierarchical representation of domains and capabilities created from intent taxonomy. Knowledge graph 750 is a hierarchical representation of the users' 310 interactions history.

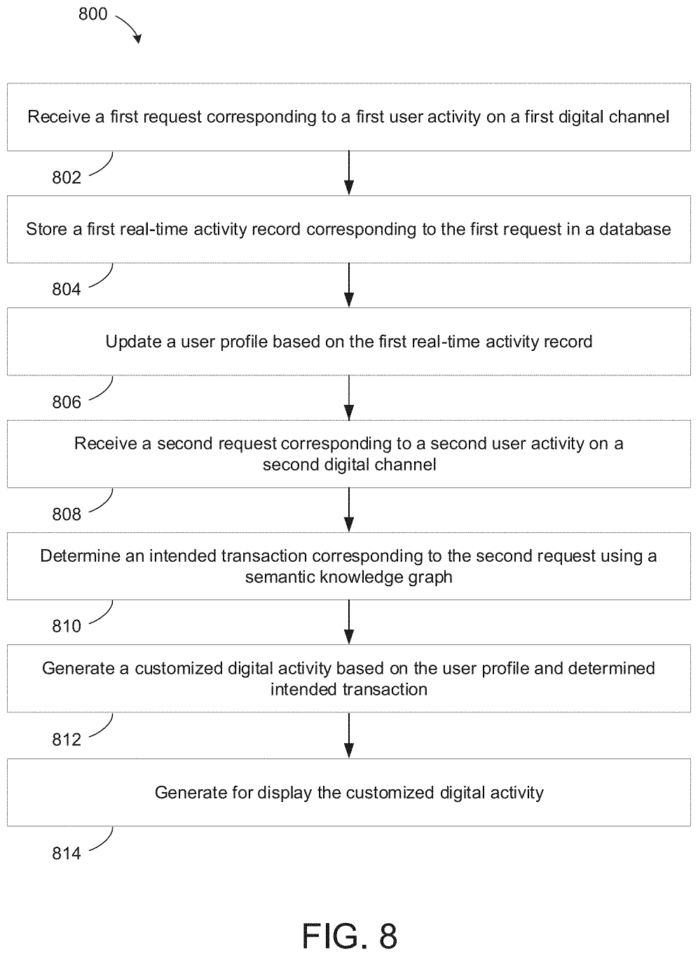

Referring to FIG. 8, a process 800 for synchronizing user activity across digital channels is illustrated. The process 800 begins by receiving, by a server computing device 200, a first request corresponding to a first user activity on a first digital channel via a user device 250 in step 802. Process 800 continues by storing, by the server computing device 200, a first real-time activity record corresponding to the first request in a database in step 804. For example, in some embodiments, the first real-time activity record includes a time stamp corresponding to the first request. Process 800 continues by updating, by the server computing device 200, a user profile based on the first real-time activity record in step 806.

Process 800 continues by receiving, by the server computing device 200, a second request corresponding to a second user activity on a second digital channel via the user device in step 808. For example, in some embodiments, the server computing device is configured to receive the second request corresponding to the second user activity on the second digital channel via a second user device. In some embodiments, the server computing device 200 is configured to store a second real-time activity record corresponding to the second request in the database. In some embodiments, the server computing device 200 is configured to update the user profile based on the second real-time activity record.

Process 800 continues by determining, by the server computing device 200, an intended transaction corresponding to the second request using a semantic knowledge graph in step 810. For example, in some embodiments, the server computing device 200 is configured to determine the intended transaction based on the first request and the second request. In some embodiments, the semantic knowledge graph includes entity capability models. Process 800 continues by generating, by the server computing device 200, a customized digital activity based on the user profile and determined intended transaction in step 812.

Process 800 finishes by generating, by the server computing device 200, for display the customized digital activity on the user device 250 in step 814. For example, in some embodiments, the server computing device 200 is configured to generate for display the customized digital activity on the first digital channel via the user device. In other embodiments, the server computing device 200 is configured to generate for display the customized digital activity on a second device.

In some aspects, process 800 can be implemented on a system 400 for synchronizing user activity across digital channels. The system includes a server computing device 200 communicatively coupled to a user device 250 and a database over a network 150. The server computing device 200 is configured to receive a first request corresponding to a first user activity on a first digital channel via the user device 250. The server computing device 200 is also configured to store a first real-time activity record corresponding to the first request in the database. The server computing device 200 is also configured to update a user profile based on the first real-time activity record.

Further, the server computing device 200 is configured receive a second request corresponding to a second user activity on a second digital channel via the user device. The server computing device 200 is also configured to determine an intended transaction corresponding to the second request using a semantic knowledge graph. Further, the server computing device 200 is configured to generate a customized digital activity based on the user profile and determined intended transaction. The server computing device 200 is further configured to generate for display the customized digital activity on the user device 250.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The above-described techniques can be implemented using supervised learning and/or machine learning algorithms. Supervised learning is the machine learning task of learning a function that maps an input to an output based on example input-output pairs. It infers a function from labeled training data consisting of a set of training examples. Each example is a pair consisting of an input object and a desired output value. A supervised learning algorithm or machine learning algorithm analyzes the training data and produces an inferred function, which can be used for mapping new examples.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

1. A computerized method for synchronizing user activity across a plurality of digital channels, the method comprising:
receiving, by a server computing device, a first request corresponding to a first user activity on a first digital channel via a user device;
storing, by the server computing device, a first real-time activity record corresponding to the first request in a database, the first real-time activity record comprising a first user intent that is generated from the first request using an intent naming scheme;
updating, by the server computing device, a user profile based on the first real-time activity record;
receiving, by the server computing device, a second request corresponding to a second user activity on a second digital channel via the user device;
determining, by the server computing device, an intended transaction corresponding to the second request using a semantic knowledge graph, comprising traversing the semantic knowledge graph using a second user intent generated from the second request using the intent naming scheme;
generating, by the server computing device, a customized digital activity based on the user profile and determined intended transaction; and
generating, by the server computing device, for display the customized digital activity on the user device.

2. The computerized method of claim 1, wherein the server computing device is further configured to store a second real-time activity record corresponding to the second request in the database, the second real-time activity record comprising the second user intent.

3. The computerized method of claim 2, wherein the server computing device is further configured to update the user profile based on the second real-time activity record.

4. The computerized method of claim 1, wherein the semantic knowledge graph comprises a plurality of entity capability models.

5. The computerized method of claim 1, wherein the first real-time activity record comprises a time stamp corresponding to the first request.

6. The computerized method of claim 1, wherein the server computing device is further configured to determine the intended transaction based on the first request and the second request, including traversing the semantic knowledge graph using the first user intent and the second user intent.

7. The computerized method of claim 1, wherein the server computing device is further configured to generate for display the customized digital activity on the first digital channel via the user device.

8. The computerized method of claim 1, wherein the server computing device is further configured to generate for display the customized digital activity on the second digital channel via the user device.

9. The computerized method of claim 1, wherein the server computing device is further configured to generate for display the customized digital activity on a second user device.

10. The computerized method of claim 1, wherein the server computing device is further configured to receive the second request corresponding to the second user activity on the second digital channel via a second user device.

11. A system for synchronizing user activity across a plurality of digital channels, the system comprising a server computing device communicatively coupled to a user device and a database over a network, the server computing device configured to:
receive a first request corresponding to a first user activity on a first digital channel via the user device;
store a first real-time activity record corresponding to the first request in the database, the first real-time activity record comprising a first user intent that is generated from the first request using an intent naming scheme;
update a user profile based on the first real-time activity record;
receive a second request corresponding to a second user activity on a second digital channel via the user device;
determine an intended transaction corresponding to the second request using a semantic knowledge graph, comprising traversing the semantic knowledge graph using a second user intent generated from the second request using the intent naming scheme;
generate a customized digital activity based on the user profile and determined intended transaction; and
generate for display the customized digital activity on the user device.

12. The system of claim 11, wherein the server computing device is further configured to store a second real-time activity record corresponding to the second request in the database, the second real-time activity record comprising the second user intent.

13. The system of claim 12, wherein the server computing device is further configured to update the user profile based on the second real-time activity record.

14. The system of claim 11, wherein the semantic knowledge graph comprises a plurality of entity capability models.

15. The system of claim 11, wherein the first real-time activity record comprises a time stamp corresponding to the first request.

16. The system of claim 11, wherein the server computing device is further configured to determine the intended transaction based on the first request and the second request, including traversing the semantic knowledge graph using the first user intent and the second user intent.

17. The system of claim 11, wherein the server computing device is further configured to generate for display the customized digital activity on the first digital channel via the user device.

18. The system of claim 11, wherein the server computing device is further configured to generate for display the customized digital activity on the second digital channel via the user device.

19. The system of claim 11, wherein the server computing device is further configured to generate for display the customized digital activity on a second user device.

20. The system of claim 11, wherein the server computing device is further configured to receive the second request corresponding to the second user activity on the second digital channel via a second user device.
